(19) United States
(12) Patent Application Publication
(10) Pub. No.: US 2016/0349902 A1
(43) Pub. Date: Dec. 1, 2016

(54) INFORMATION-TERMINAL DEVICE

(71) Applicant: SHARP KABUSHIKI KAISHA, Sakai-shi, Osaka (JP)

(72) Inventors: Shigehiro TORII, Sakai-shi (JP); Satoshi EGUCHI, Sakai-shi (JP); Eiji FUMIMOTO, Sakai-shi (JP); Yuhji MAEJIMA, Sakai-shi (JP); Yu YUMURA, Sakai-shi (JP)

(21) Appl. No.: 15/114,491

(22) PCT Filed: Jan. 22, 2015
(86) PCT No.: PCT/JP2015/051702

§ 371 Date: Jul. 27, 2016

(30) Foreign Application Priority Data
Feb. 27, 2014 (JP) 2014-037326

(51) Int. Cl. G06F 3/041; G06F 3/16

(52) U.S. Cl. CPC G06F 3/0416; G06F 3/165; G06F 2203/04106

(57) ABSTRACT

The information terminal device (1) of the present invention includes an operation determining section (43). The operation determining section (43) releases locking of an operation carried out with respect to an active application in the information terminal device (1), in a case where a holding of the information terminal device (1) by a user is detected while the operation is being locked. This prevents the user from carrying out an unintended operation with respect to an active application, instead of making operations complex.

### TECHNICAL FIELD

The present invention relates to an information terminal device that controls locking of an operation carried out with respect to an active application, and relates to a control program for the information terminal device.

### BACKGROUND ART

Information terminal devices, such as smartphones and tablets, have a problem that they may operate in response to an unintended touch of a user on an input section such as a touch panel. In order to address such a problem, there have been proposed various conventional techniques for preventing malfunction with use of a grip sensor. For example, Patent Literature 1 discloses a technique in which touch detection sensitivity is made higher (i) in an operation member, located farther from a grip section, than (ii) in an operation member located closer to the grip section, in an image capturing device, such as a single-lens reflex camera, in which a user operates a plurality of operation members constituted by touch sensors while having the image capturing device in his/her hand.

### CITATION LIST

### Patent Literature

[Patent Literature 1]

Japanese Patent Application Publication Tokukai No. 2013-25503 (Publication date: Feb. 4, 2013)
[Patent Literature 2]

Japanese Patent Application Publication Tokukai No. 2012-170071 (Publication date: Sep. 6, 2012)

### SUMMARY OF INVENTION

### Technical Problem

Such conventional techniques, however, have not considered whether or not an application is active in their respective information terminal devices. This gives rise to a problem that it is not possible to prevent a user from carrying out an unintended operation with respect to an active application. Meanwhile, in a case where such (i) an operation, which is carried out with respect to an active application, is locked and (ii) a user attempts to carry out the operation, the user first needs to carry out another operation intended for releasing the locking, such as an operation intended for pressing on a specific button. This causes a problem that operations become complex.

The present invention is attained in view of the above problem. An object of the present invention is to prevent a user from carrying out an unintended operation with respect to an active application in an information terminal device, instead of making operations complex.

### Solution to Problem

In order to attain the above object, an information terminal device of the present invention is an information terminal device that is capable of being held by a user, is capable of locking an operation carried out with respect to an active application, and releases the locking of the operation only in a case where the information terminal device receives a given input, the information terminal device including: a releasing section that releases the locking of the operation carried out with respect to the active application, in a case where a holding of the information terminal device by the user is detected while the operation is being locked.

### Advantageous Effects of Invention

An aspect of the present invention brings about an effect of enabling to prevent a user from carrying out an unintended operation with respect to an active application in an information terminal device, instead of making operations complex.

### BRIEF DESCRIPTION OF DRAWINGS

FIG. 1 is a functional block diagram illustrating an information terminal device of Embodiment 1 of the present invention.

FIG. 2 is a flowchart of a process carried out by the information terminal device of Embodiment 1 of the present invention.

FIG. 3 is a view illustrating how a volume change operation is carried out with respect to the information terminal device of each embodiment of the present invention.

FIG. 4 is a functional block diagram illustrating an information terminal device of Embodiment 2 of the present invention.

FIG. 5 is a flowchart of a process carried out by the information terminal device of Embodiment 2 of the present invention.

### DESCRIPTION OF EMBODIMENTS

### Embodiment 1

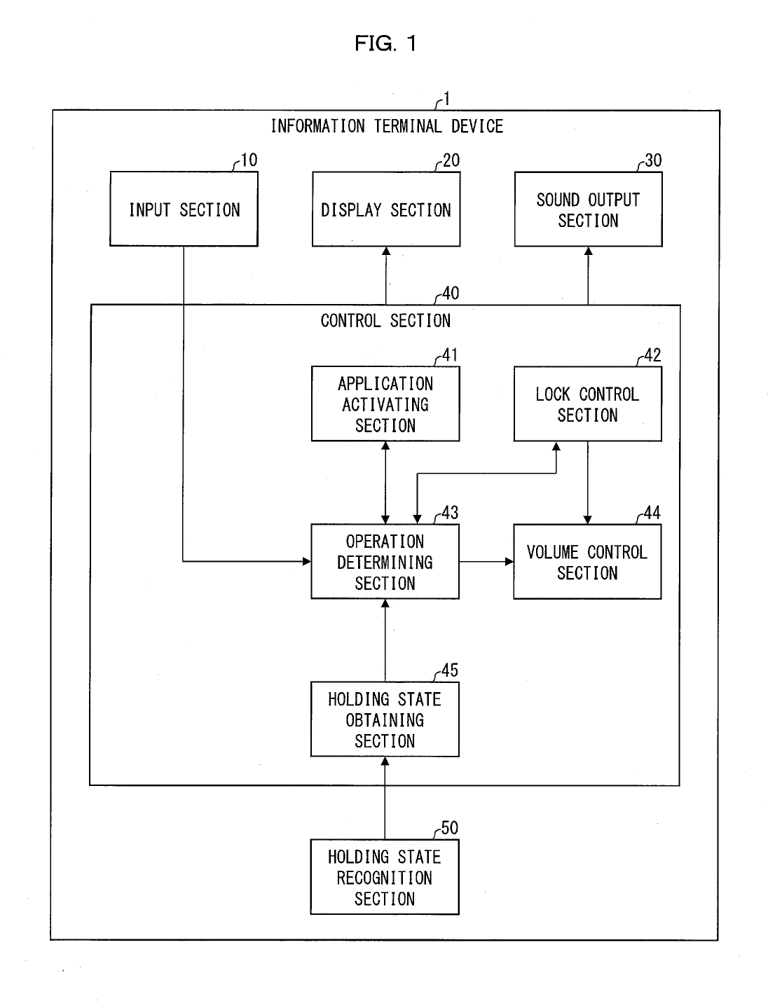

The following description will discuss Embodiment 1 of the present invention, with reference to FIGS. 1 through 3.

[Configuration of Information Terminal Device 1]

A configuration of an information terminal device 1 will be first discussed below with reference to FIG. 1. FIG. 1 is a functional block diagram illustrating the information terminal device 1 of Embodiment 1 in accordance with the present invention. As illustrated in FIG. 1, the information terminal device 1 includes an input section 10, a display section 20, a sound output section 30, a control section 40, and a holding state recognition section 50. The input section 10 is provided at a given position of the information terminal device 1. The input section 10 converts, for example, pressing on the input section 10 and/or touching on the input section 10 with a finger or a stylus, into a signal, and then supplies the signal thus converted to the control section 40. A touch with a finger or a stylus is converted into a signal by use of, for example, an electrostatic induction, a resistance film, or optics. Note that the “touch” as used herein means an operation that includes at least one of proximity to and contact with a specific object.

The display section 20 receives information on a display image from the control section 40, and displays the display image on a display screen. The display section 20 includes (i) a display device, such as a liquid crystal display (LCD) or an electroluminescence (EL) display, and (ii) a driver circuit that drives the display device in accordance with received image data. The control section 40 controls the display section 20 to switch between an ON state and an OFF state. Note that (i) the ON state and the OFF state of the display section 20 respectively mean an ON state and an OFF state of a backlight in the case of, for example, an LCD and (ii) the ON state and the OFF state of the display section 20 respectively mean an ON state and an OFF state of EL elements in the case of, for example, an EL display.

The sound output section 30 outputs a sound in response to a signal supplied from the control section 40. The sound output section 30 can be a flat speaker that vibrates a surface of the information terminal device 1, and can include an amplifier circuit and/or a digital to analog (D/A) convertor.

The holding state recognition section 50 is a sensor that detects contact to a surface of the information terminal device 1. The holding state recognition section 50 supplies, to the control section 40, information on detected contact to a surface of the information terminal device 1.

The control section 40 includes an application activating section 41, a lock control section 42, an operation determining section 43 (releasing section), a volume control section 44, and a holding state obtaining section 45 (detection section) (see FIG. 1). The application activating section 41 activates applications, such as a music playback application and a video playback application, so that the display section 20 displays an image and/or the sound output section 30 outputs a sound.

The lock control section 42 (i) holds information indicating whether or not an operation, carried out with respect to a given application, is locked and (ii) supplies the information in response to an inquiry from sections, in the control section 40, other than the lock control section 42. According to Embodiment 1, the lock control section 42 particularly controls locking of an operation (hereinafter, referred to as a volume change operation) intended for changing a volume of a sound played back by a given application activated by the application activating section 41.

The operation determining section 43 determines, based on a signal supplied from the input section 10, whether or not the volume change operation is carried out, and then gives an instruction, in accordance with a determined result, to the volume control section 44. The operation determining section 43 releases the locking of the volume change operation, in a case where a holding of the information terminal device 1 by a user is detected while (i) a sound is being played back by an active application in the information terminal device 1 and (ii) the volume change operation is being locked. Details of the process will be later described.

In a case where the volume change operation is not locked, the volume control section 44 changes, in response to an instruction given by the operation determining section 43, a volume of a sound to be played back by the sound output section 30. Specifically, in a case where the volume control section 44 receives, from the operation determining section 43, an instruction on changing a volume, the volume control section 44 inquires the lock control section 42 as to whether or not the volume change operation is locked. In a case where the volume control section 44 receives an answer in which the volume change operation is not locked, the volume control section 44 changes the volume. It follows that, in a case where the volume change operation is locked, the volume control section 44 does not change a volume of a sound to be played back by the sound output section 30.

The holding state obtaining section 45 determines, based on a signal supplied from the hold state recognition section 50, whether or not the information terminal device 1 has been held, and then notifies a determined result. Such a determination can be made (i) in response to an inquiry from other sections of the control section 40 or (ii) in response to a signal supplied from the holding state recognition section 50.

[2. Flow of Process Related to Lock Control By Information Terminal Device 1]

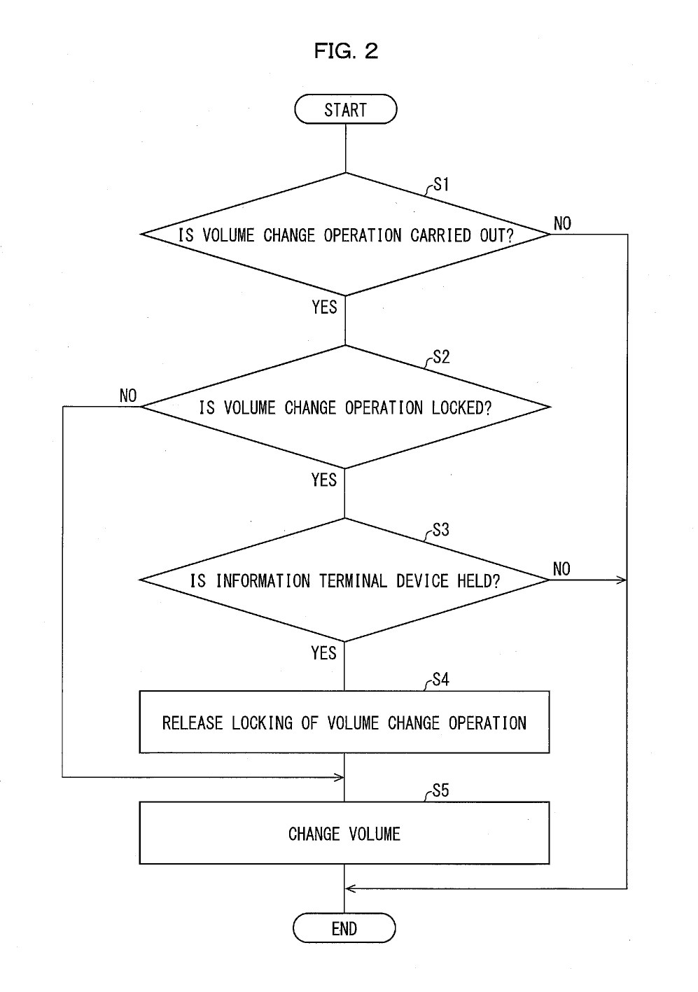

A flow of a process carried out by the information terminal device 1 will be described below with reference to FIG. 2. FIG. 2 is a flowchart illustrating how the lock control is carried out by the information terminal device 1 that outputs a sound in response to a given application that is active.

The operation determining section 43 first determines, based on a signal supplied from the input section 10, whether or not a volume change operation has been carried out (S1). In a case where no volume change operation has been carried out (NO in S1), the process illustrated in the flowchart (hereinafter, this process will be simply referred to as “the process”) ends.

In a case where the volume change operation is carried out (YES in S1), the operation determining section 43 inquires the lock control section 42 as to whether or not the volume change operation is locked. In response to the inquiry from the operation determining section 43, the lock control section 42 determines whether or not the volume change operation is locked (S2), and supplies a determined result to the operation determining section 43.

In a case where the volume change operation is not locked (NO in S2), the operation determining section 43 causes the volume control section 44 to change a volume of a sound played back by a given application (S5). In a case where the volume change operation is locked (YES in S2), the operation determining section 43 inquires the holding state obtaining section 45 as to whether or not the information terminal device has been held. Upon receipt of the inquiry from the operation determining section 43, the holding state obtaining section 45 determines, based on information supplied from the holding state recognition section 50, whether or not the information terminal device 1 has been held (S3), and supplies a determined result to the operation determining section 43. In a case where the information terminal device 1 has not been held (NO in S3), the process ends.

In a case where the information terminal device 1 has been held (YES in S3), the operation determining section 43 (i) causes the lock control section 42 to release the locking of the volume change operation (S4), (ii) causes the volume control section 44 to change the volume of the sound played back by the given application (S5), and (iii) terminates the process.

Note that the information terminal device 1 can be configured to repeat, after the process ends, the process from 51.

By carrying out the process, locking of the volume change operation is released in a case where the information terminal device 1 has been held while the volume change operation is being locked. This causes the volume change operation to be kept locked until a user holds the information terminal device. This ultimately can prevent the user from carrying out an unintended operation with respect to an active application. Furthermore, the user can release locking of the volume change operation by simply holding the information terminal device, instead of carrying out an operation such as pressing on a specific button. That is, it is possible to prevent the user from carrying out an unintended operation with respect to an active application in the information terminal device, instead of making operations complex.

Moreover, the user can carry out a volume change operation while checking, via an outputted sound, a result of the volume change operation. Note that an operation, such as an operation carried out to select music, which is related to a sound played back by an active application in the information terminal device 1 can be carried out instead of the volume change operation.

[3. Volume Change Operation Carried Out in Information Terminal Device 1]

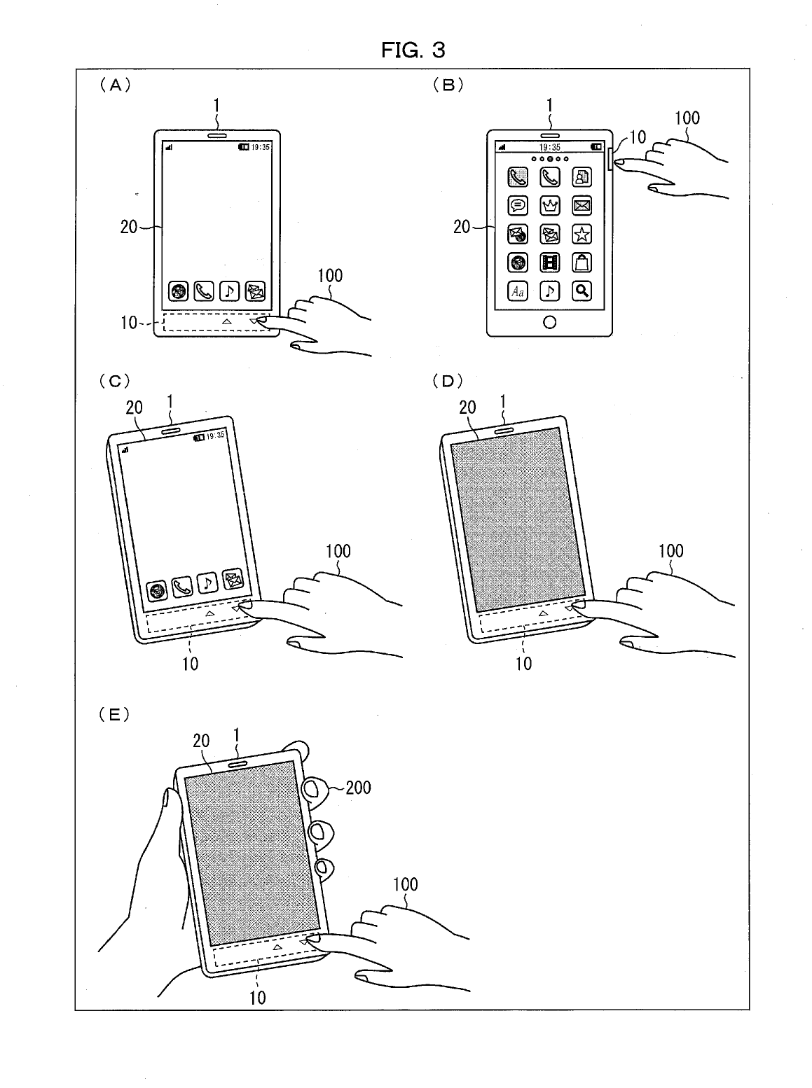

The following description will discuss, with reference to FIG. 3, how the volume change operation is carried out with respect to the information terminal device 1. (A) and (B) of FIG. 3 each illustrate how the user carries out a volume change operation. (A) of FIG. 3 illustrates how the user carries out a voice control operation, by touching of a user's hand 100 with respect to the input section 10. (B) of FIG. 3 illustrates how the user carries out the volume change operation by pressing down of the user's hand 100 with respect to the input section 10. In especial, in a case where the information terminal device 1 is configured such that the volume change operation is carried out by a touch (see (A) of FIG. 3), it is possible, instead of making operations complex, to prevent the user from changing a volume of a sound, played back by an active application in the information terminal device, due to an unintended touch of the user (e.g., an unintended touch on the information terminal device 1 caused in a bag or a pocket).

Note that how the input section 10 of the information terminal device 1 is located and configured, is not limited to the input section 20 illustrated in (A) and (B) of FIG. 3. More specifically, the input section 10 can be provided so as to (i) be in plane with a display surface of the display screen of the information terminal device 1 or (ii) in a surface other than the display surface of the information terminal device 1, such as a side surface or a back surface of a housing of the information terminal device 1. The input section 10 can be configured by (i) hardware keys for detecting pressing down or (ii) one of various sensors each detecting a touch.

[Variation]

A variation of the information terminal device 1 of Embodiment 1 can be alternatively configured such that the volume change operation is locked again at a time (i) when the process in S5 was carried out or (ii) when the holding of the information terminal device 1 was released after the process in S5. With the configuration, it is possible to prevent a user from making an unintended change in volume when the user has released the holding of the information terminal device 1.

### Embodiment 2

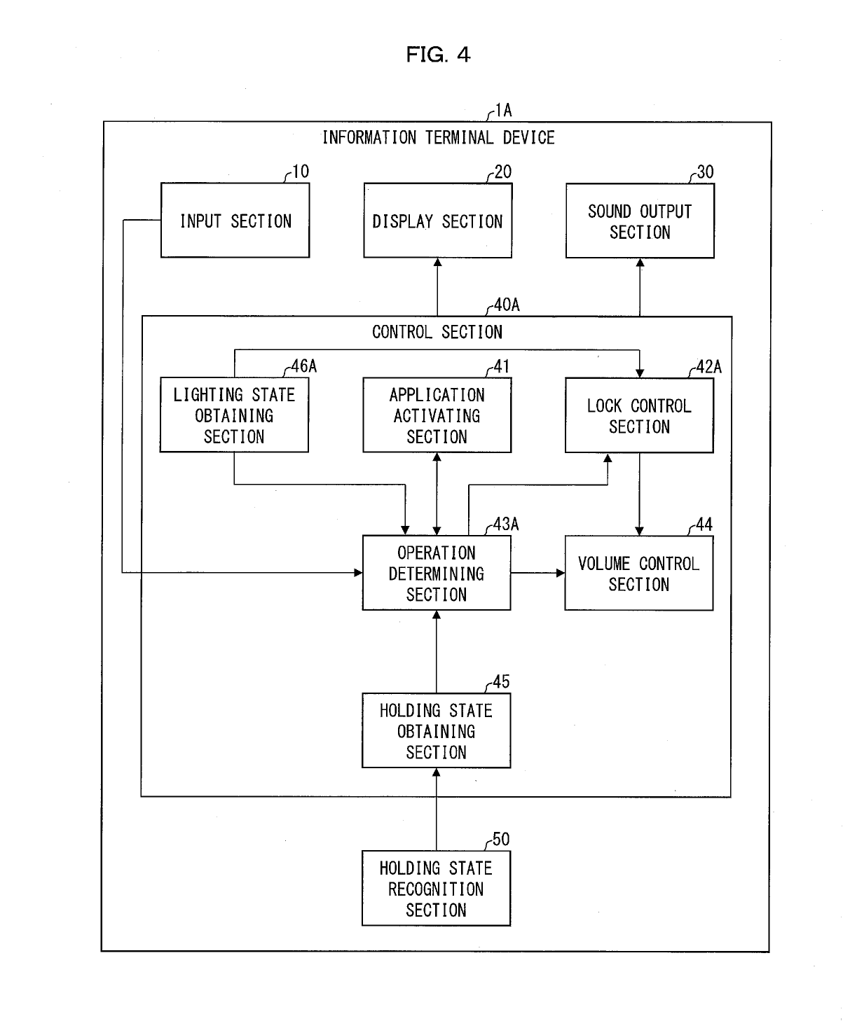

The following description will discuss Embodiment 2 of the present invention with reference to FIGS. 3 through 5. Note that, for convenience, members having functions identical to those discussed in Embodiment 1 are given the same reference numerals and explanation thereof is omitted.

[1. Summary of How to Control Locking of Volume Change Operation in Information Terminal Device 1A]

The following description will first discuss, with reference to (C) through (E) of FIG. 3, a summary of how to control the locking of a volume change operation in the information terminal device 1A of Embodiment 2. (C) through (E) of FIG. 3 each illustrate how the volume change operation is carried out in Embodiment 2.

(C) of FIG. 3 illustrates how a volume change operation identical to that illustrated in (A) of FIG. 3 is being carried out, in a case where a display section 20 is in an ON state and the locking of the volume change operation has been released. In such a case, a volume of a sound outputted by the information terminal device 1A is changed.

(D) of FIG. 3 illustrates a case where the display section 20 has been changed into a turned-OFF state from the state illustrated in (C) of FIG. 3. In such a case, since the volume change operation is locked in response to an OFF state of the display section 20, a volume of a sound outputted by the information terminal device 1A will not be changed even if a user carries out the volume change operation.

(E) of FIG. 3 illustrates a case where the information terminal device 1 is being held and the volume change operation is being carried out, in the state illustrated (D) of FIG. 3. In such a case, since the locking of the volume change operation is released, a volume of a sound outputted by the information terminal device 1A is to be changed.

[2. How Information Terminal Device 1A is Configured and is Processed]

The information terminal device 1A differs from the information terminal device 1 in that it includes a control section 40A, instead of the control section 40. The control section 40A includes a lock control section 42A and an operation determining section 43A, instead of the lock control section 42 and the operation determining section 43, and further includes a lighting state obtaining section 46A.

The lock control section 42A differs from the lock control section 42 in that it locks the volume change operation in a case where the lock control section 42A is notified, by the lighting state obtaining section 46A, of an OFF state of the display section 20. This causes the volume change operation to be locked at a time when the display section 20 has been turned OFF.

The lighting state obtaining section 46A obtains lighting information indicating whether the display section 20 is in an ON state or in an OFF state. The lighting state obtaining section 46A notifies the lock control section 42 of an OFF state of the display section 20, in a case where the display section 20 has been turned OFF.

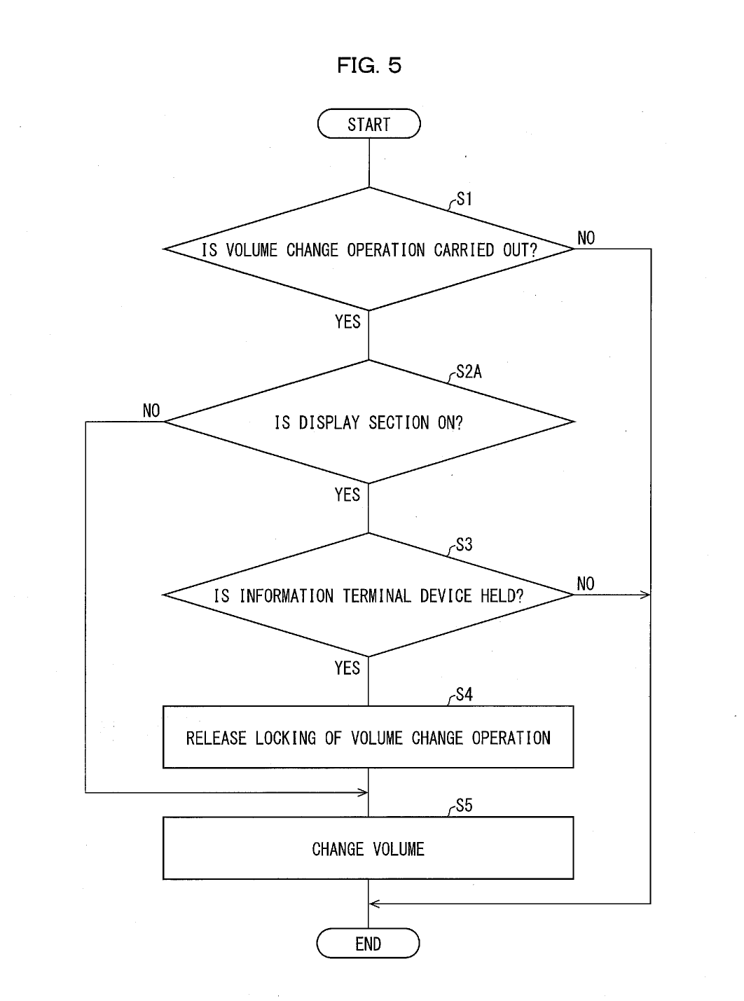

The operation determining section 43A differs from the operation determining section 43 in that it inquires the lighting state obtaining section 46A as to whether or not the display section 20 has been turned OFF, instead of inquiring the lock control section 42 as to whether or not the volume change operation is locked. How to be specifically processed will be described with reference to FIG. 5. Note that the operation determining section 43A does not turn ON the display section 20 in a case where it releases the locking of the volume change operation.

FIG. 5 is a flowchart illustrating how the lock control is carried out by the information terminal device 1A that outputs a sound in response to a given application that is active. FIG. 5 differs from FIG. 2 in that it includes S2A, instead of S2.

Specifically, in a case where a volume change operation is carried out (YES in S1), the operation determining section 43 inquires the lighting state obtaining section 46A as to whether or not the display section 20 has been turned OFF. In response to the inquiry from the operation determining section 43, the lighting state obtaining section 46A determines whether or not the display section 20 has been turned OFF (S2A), and then supplies a determined result to the operation determining section 43. In a case where the display section 20 has been turned OFF (YES in S2A), S3 is proceeded. In a case where the display section 20 has not been turned OFF (NO in S2A), i.e., in a case where the display section 20 has been turned ON, S5 is proceeded.

With the above process, the display section 20 is kept turned OFF even in a case where a user holds the information terminal device 1A so as to release locking of a volume change operation, carried out with respect to a sound outputted by an active application, after the volume change operation is locked at a time when the display section 20 is turned OFF. This allows a reduction in electric power consumed by the information terminal device 1A in a case where the user carries out such an operation.

Note that, according to an alternative configuration, the display section 20 can be a touch panel. In such an alternative configuration, the information terminal device 1A can be configured such that no input can be entered while the display section 20 is in an OFF state. In a case where the display section 20 is a touch panel, a touch sensor of the display section 20 can be configure to (i) be integral with the input section 10 or (ii) be independently of the input section 10.

### Embodiment 3

Control blocks (particularly, the control sections 40 and 40A) of the information terminal devices 1 and 1A each can be realized by a logic circuit (hardware) provided in an integrated circuit (IC chip) or the like or can be alternatively realized by software as executed by a central processing unit (CPU).

In the latter case, each of the information terminal devices 1 and 1A includes a CPU that executes instructions of a program that is software realizing the foregoing functions; a read only memory (ROM) or a storage device (each referred to as “storage medium”) in which the program and various kinds of data are stored so as to be readable by a computer (or a CPU); and a random access memory (RAM) in which the program is loaded. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be supplied to the computer via any transmission medium (such as a communication network or a broadcast wave) which allows the program to be transmitted. Note that the present invention can also be achieved in the form of a computer data signal in which the program is embodied via electronic transmission and which is embedded in a carrier wave.

[Main Points]

An information terminal device (1 or 1A) of a first aspect of the present invention is an information terminal device that is capable of being held by a user, is capable of locking an operation carried out with respect to an active application, and releases the locking of the operation only in a case where the information terminal device receives a given input, the information terminal device including: a releasing section (operation determination section 43 or 43A) that releases the locking of the operation carried out with respect to the active application, in a case where a holding of the information terminal device by the user is detected while the operation is being locked.

According to the above configuration, in a case where the information terminal device is held while an operation carried out with respect to an active application is being locked, the locking of the operation carried out with respect to the active application is released. This causes the operation carried out with respect to the active application to be kept locked until the user holds the information terminal device. This ultimately can prevent the user from carrying out an unintended operation with respect to an active application. Further, the user can release locking of the operation by simply holding the information terminal device, instead of carrying out an operation such as pressing on a specific button. That is, it is possible to prevent the user from carrying out an unintended operation with respect to an active application in the information terminal device, instead of making operations complex. Note that the operation carried out with respect to the active application means an operation related to a process carried out by the active application. For example, the operation carried out with respect to the active application is an operation intended for increasing or decreasing a volume of a sound played back by the active application.

In a second aspect of the present invention, the information terminal device can be arranged such that, in the first aspect of the present invention, the operation carried out with respect to the active application is locked at a time when a display section (20) of the information terminal device has been turned OFF, and the releasing section releases the operation while keeping the display section turned OFF.

According to the above configuration, the display section is kept turned OFF even in a case where a user holds the information terminal device so as to release the locking of the operation, carried out with respect to the active application, after the operation is locked at a time when the display section of the information terminal device is turned OFF. This allows a reduction in electric power consumed by the information terminal device in a case where the user carries out such an operation.

In a third aspect of the present invention, the information terminal device can be arranged such that, in the aspect 1 or 2 of the present invention, the operation carried out with respect to the active application is related to a sound outputted by the active application.

According to the above configuration, the user can carry out the operation while checking, via an outputted sound, a result of the operation. Note that the operation related to a sound outputted by the active application can be an operation intended for increasing or decreasing a volume of the sound, or an operation intended for selecting a sound to be played back by the active application.

In a fourth aspect of the present invention, the information terminal device can be arranged such that, in any one of the first through third aspect of the present invention, the operation carried out with respect to the active application is an operation based on a touch on an input section (10) of the information terminal device.

According to the above configuration, it is possible, instead of making operations complex, to prevent the user from carrying out an operation due to an unintended touch on the active application in the information terminal device.

The information terminal device of each aspect of the present invention may be realized by a computer. In this case, the present invention encompasses: a control program for the information terminal device which program causes a computer to operate as each section of the information terminal device so that the information terminal device can be realized by the computer; and a computer-readable storage medium storing therein the control program.

The present invention is not limited to the embodiments, but can be altered by a skilled person in the art within the scope of the claims. An embodiment derived from a proper combination of technical means each disclosed in a different embodiment is also encompassed in the technical scope of the present invention. Further, it is possible to form a new technical feature by combining the technical means disclosed in the respective embodiments.

### INDUSTRIAL APPLICABILITY

The present invention is applicable to an information terminal device, such as a smartphone and a tablet, which is capable of being held by a user.

### REFERENCE SIGNS LIST

1, 1A Information terminal device
10 Input section
20 Display section
43, 43A Operation determining section (releasing section)

1. An information terminal device that is capable of being held by a user, is capable of locking an operation carried out with respect to an active application, and releases the locking of the operation only in a case where the information terminal device receives a given input,
the information terminal device comprising:
a releasing section that releases the locking of the operation carried out with respect to the active application, in a case where a holding of the information terminal device by the user is detected while the operation is being locked.

2. The information terminal device as set forth in claim 1, wherein:
the operation carried out with respect to the active application is locked at a time when a display section of the information terminal device has been turned OFF; and
the releasing section releases the locking of the operation while keeping the display section turned OFF.

3. The information terminal device as set forth in claim 1, wherein:
the operation carried out with respect to the active application is related to a sound outputted by the active application.

4. The information terminal device as set forth in claim 1, wherein:
the operation carried out with respect to the active application is an operation by a touch on an input section of the information terminal device.

5. (canceled)
